(19) United States
(12) Patent Application Publication
(10) Pub. No.: US 2024/0309154 A1
(43) Pub. Date: Sep. 19, 2024

(54) GRAFTED EPDM POLYMERS AND RUBBER COMPOSITIONS EMPLOYING SAME

(71) Applicant: BRIDGESTONE CORPORATION, Tokyo (JP)

(72) Inventor: Madoka Kimura, Chuo-ku (JP)

(21) Appl. No.: 18/260,054

(22) PCT Filed: Dec. 27, 2021
(86) PCT No.: PCT/JP2021/049039

§ 371 Date: Jun. 30, 2023

Related U.S. Application Data
(60) Provisional application No. 63/132,537, filed on Dec. 31, 2020.

(51) Int. Cl. C08G 81/02

(52) U.S. Cl. CPC C08G 81/021

(57) ABSTRACT

A polymer that includes or consists of polyene mer is grafted to an EPDM, with the former attaching to the latter at the spot where the residual unsaturation of the diene monomer portion of the latter formerly had been located. The resulting macromolecule tends to exhibit smaller EPDM domains, i.e., better dispersion.

The present invention relates to a grafted EPDM polymer and rubber compositions employing same. This international application claims the benefit of U.S. patent appl. No. 63/132,537, filed 31 Dec. 2020, the entirety of which is incorporated herein by reference.

### TECHNICAL FIELD

### Background Art

Rubber goods such as tire components (e.g., treads, sidewalls, etc.) often are made from elastomeric compositions that contain one or more reinforcing materials such as, for example, particulate carbon black and silica.

Good traction and resistance to abrasion are primary considerations for tire treads; however, motor vehicle fuel efficiency concerns argue for a minimization in their rolling resistance, which correlates with a reduction in hysteresis and heat build-up during operation of the tire. These considerations are, to a great extent, competing and somewhat contradictory: treads made from compositions designed to provide good road traction usually exhibit increased rolling resistance and vice versa.

With respect to tire sidewalls, ozone resistance is a primary consideration, but a competing consideration tends to be a desire to reduce overall tire weight (so as to improve automobile mileage). Where the amount of rubber composition used to provide the sidewall component is decreased, however, ozone resistance tends to fall due to the lower amounts of antioxidants present.

Because ozone resistance is so important in tire sidewalls, interest in the inclusion of ethylene/propylene/diene monomer (EPDM) polymers therein continues. EPDM is known to be highly resistant to ozone (and hence ozone degradation), although its resistance to crack growth is not particularly good. The latter sometimes is addressed by use of blends which include EPDM. Regardless, inclusion of EPDM in such rubber compositions in lieu of another polymer tends to permit reduction of the amounts of antioxidants included in the composition, which is desirable for the aforementioned weight reduction reasons.

Vulcanizates prepared from blends of the type described above can suffer from ozone-induced cracking unless and until the amount of EPDM reaches a critical minimum, often ˜25 phr EPDM. This is theorized to result from the tendency of EPDM to disperse inadequately in polymers including conjugated diene mer such as, for example, polybutadiene (BR), natural rubber (NR), and the like.

That which remains desirable is a cost-effective manner for enhancing the dispersion of EPDM in such polymers. Also desirable are rubber compositions, as well as vulcanizates prepared therefrom, which can resist ozone-induced cracking even when the amount of EPDM employed is less than the aforementioned critical minimum.

### DISCLOSURE OF INVENTION

### Summary of Invention

Provided herein is a macromolecule in which a polymer that includes or consists of polyene mer (e.g., a polydiene) is grafted to an EPDM, with the point of attachment being the position where the residual unsaturation of the diene monomer portion of the latter previously had been located. The resulting macromolecule tends to exhibit smaller EPDM domains, i.e., better dispersion, than mere blends.

In another aspect is provided a method for providing the macromolecule in which a functionalized EPDM reacts with a carbanionic polymer that includes polyene mer, e.g., a polydiene. The functional group of the functionalized EPDM is reactive toward carbanions, with epoxy groups being a non-limiting example.

Inclusion of the macromolecule in a rubber composition can permit reduction in the total amount of EPDM included without degrading resistance to ozone-induced cracking in vulcanizates provided therefrom.

Other aspects of the present invention will be apparent to the ordinarily skilled artisan from the detailed description that follows. To assist in understanding that description, certain definitions are provided immediately below, and these are intended to apply throughout unless the surrounding text explicitly indicates a contrary intention:
“polymer” means the polymerization product of one or more monomers and is inclusive of homo-, co-, ter-, tetra polymers, etc.;
“mer” or “mer unit” means that portion of a polymer derived from a single reactant molecule (e.g., ethylene mer has the general formula —CH₂CH₂);
“copolymer” means a polymer that includes mer units derived from two reactants, typically monomers, and is inclusive of random, block, segmented, graft, etc., copolymers;
“interpolymer” means a polymer that includes mer units derived from at least two reactants, typically monomers, and is inclusive of copolymers, terpolymers, tetrapolymers, and the like;
“gum Mooney viscosity” is the Mooney viscosity of an uncured polymer prior to addition of any filler(s);
“substituted” means one containing a heteroatom or functionality (e.g., hydrocarbyl group) that does not interfere with the intended purpose of the group in question;
“directly bonded” means covalently attached with no intervening atoms or groups;
“polyene” means a molecule with at least two double bonds located in the longest portion or chain thereof, and specifically is inclusive of dienes, trienes, and the like;
“polydiene” means a polymer that includes mer units from one or more dienes;
“rubber” means a natural and/or synthetic polymer that includes at least 50% (w/w) polyene mer; and
“phr” means parts by weight (pbw) per 100 pbw rubber.

Throughout this document, all values given in the form of percentages are weight percentages (w/w) unless the surrounding text explicitly indicates a contrary intention.

Unless otherwise indicated, all numbers expressing quantities of ingredients, process conditions (e.g., time and temperature), and the like are to be understood as inherently including the term “about.” Recited numerical limitations include an appropriate degree of precision based on the number of significant places used; for example, “up to 5.0” can be read as setting a lower absolute ceiling than “up to 5.”

The relevant teachings of all patent documents mentioned throughout are incorporated herein by reference.

### DESCRIPTION OF EMBODIMENTS

The macromolecule summarily described in the preceding section has portions resulting from EPDM and a polymer that includes polyene mer, e.g., a polydiene.

With respect to the method of making the macromolecule, any EPDM can be utilized. All EPDM polymers have a point of residual unsaturation, i.e., the double bond which was not part of the cyclic portion of the diene monomer. This residual unsaturation can be replaced with a functional group that is more amenable to reaction with carbanions, as described in detail below.

A non-limiting example of such functional group is an epoxy group. The residual unsaturation of an EPDM can be replaced by an epoxy group via reaction of the EPDM with an epoxidizing agent such as, for example, m-chloroperoxybenzoic acid. This type of reaction typically does not require elevated temperature and can be performed in any solvent in which the two reactants are at least somewhat soluble. An exemplary set of condition is provided in the Examples section which follows.

The grafted segment of the macromolecule results from a carbanionic polymer, specifically, those terminally active polymers which include polyene mer, particularly diene mer and more particularly conjugated diene mer.

Polyene mer provide ethylenic unsaturation to the polymer chain. Unsaturated mer can result from incorporation of polyenes, particularly dienes and trienes (e.g., myrcene). Illustrative polyenes include C₄-C₁₂ dienes, particularly conjugated dienes such as, but not limited to, 1,3·butadiene, isoprene, 1,3-pentadiene, 2,3-dimethyl-1,3-butadiene, and 1,3-hexadiene.

Polyenes can incorporate into polymeric chains in more than one way. Controlling this manner of incorporation can be desirable, with techniques for achieving this control being discussed below.

A polymer chain with an overall 1,2-microstructure, given as a numerical percentage based on total polyene content, of from ˜10 to ˜80%, optionally from ˜25 to 65%, can be desirable for certain end use applications. A polymer that has an overall 1,2-microstructure of no more than ˜50%, preferably no more than ˜45%, more preferably no more than ˜40%, even more preferably no more than ˜35%, and most preferably no more than ˜30%, based on total polyene content, is considered to be “substantially linear.”

Although certainly not required nor even preferred, the terminally active polymer is not excluded from including directly bonded pendent aromatic groups, provided by mer units derived from vinyl aromatics, particularly the C₈-C₂₀ vinyl aromatics such as, e.g., styrene, α-methyl styrene, p methyl styrene, the vinyl toluenes, the vinyl naphthalenes, and the like. The microstructure of such interpolymers can be random, i.e., the mer units derived from each type of constituent monomer do not form blocks and, instead, are incorporated in an essentially non-repeating manner. Random microstructure can provide particular benefit in some end use applications such as, e.g., rubber compositions used in the manufacture of tire treads.

Solution polymerizations have been performed since about the mid-20th century, so the general aspects thereof are known to the ordinarily skilled artisan; nevertheless, certain aspects are provided here for convenience of reference.

Polar solvents, such as THE, or non-polar solvents can be employed in solution polymerizations, with the latter type being more common in industrial practice. Examples of non-polar solvents typically employed in anionically initiated solution polymerizations include various C₅-C₁₂ cyclic and acyclic alkanes as well as their alkylated derivatives, certain liquid aromatic compounds, and mixtures thereof. Ordinarily skilled artisans are aware of other useful solvent options and combinations.

In solution polymerizations, both randomization and vinyl content (i.e., 1,2-microstructure) can be increased by the inclusion in the polymerization ingredients of a coordinator, usually a polar compound. Up to 90 or more equivalents of coordinator per equivalent of initiator can be used, with the amount depending on, for example, the amount of vinyl content desired, the level of non-polyene monomer employed, the reaction temperature, and nature of the specific coordinator employed. Compounds useful as coordinators include organic compounds that include a heteroatom having a non-bonded pair of electrons, particularly O or N. Examples include dialkyl ethers of mono- and oligo-alkylene glycols; crown ethers; tertiary amines such as tetramethylethylene diamine; THF; THF oligomers; linear and cyclic oligomeric oxolanyl alkanes (see, e.g., U.S. Pat. No. 4,429,091) such as 2,2-bis(2′-tetrahydrofuryl)propane, di-piperidyl ethane, hexamethylphosphoramide, N,N′-dimethylpiperazine, diazabicyclooctane, diethyl ether, tributylamine, and the like.

Although ordinarily skilled artisans understand the conditions typically employed in solution polymerization, a representative description is provided for convenience of the reader. The following is based on a batch process, although it readily can be extended to, e.g., semi-batch or continuous processes. Depending on the nature of the polymer desired, the particular conditions of the solution polymerization can vary significantly.

Typically, a solution of polymerization solvent(s) and the monomer(s) is provided at a temperature of from about −70° to +150° C., more commonly from about −40° to +120° C., and typically from ˜0° to 100° C.

To this solution is added an initiating compound. Exemplary initiators include organolithium compounds, particularly alkyllithium compounds. Examples of organolithium initiators include N-lithio-hexamethyleneimine; n-butyllithium; tributyltin lithium; dialkylaminolithium compounds such as dimethylaminolithium, diethylaminolithium, dipropylaminolithium, dibutylaminolithium and the like; dialkylaminoalkyllithium compounds such as diethylaminopropyllithium; and those trialkyl stanyl lithium compounds involving C₁-C₁₂, preferably C₁-C₄, alkyl groups.

Multifunctional initiators, i.e., initiators capable of forming polymers with more than one living end, also can be used. Examples of multifunctional initiators include, but are not limited to, 1,4-dilithiobutane, 1,10-dilithiodecane, 1,20-dilithioeicosane, 1,4-dilithiobenzene, 1,4 dilithionaphthalene, 1,10-dilithioanthracene, 1,2-dilithio-1,2-diphenylethane, 1,3,5-trilithiopentane, 1,5,15-trilithioeicosane, 1,3,5 trilithiocyclohexane, 1,3,5,8-tetralithiodecane, 1,5,10,20-tetralithioeicosane, 1,2,4,6-tetralithiocyclohexane, and 4,4′-dilithiobiphenyl.

In addition to organolithium initiators, so-called functionalized initiators also can be useful. These become incorporated into the polymer chain, thus providing a functional group at the initiated end of the chain. Examples of such materials include lithiated aryl thioacetals (see, e.g., U.S. Pat. No. 7,153,919) and the reaction products of organolithium compounds and, for example, N-containing organic compounds such as substituted aldimines, ketimines, secondary amines, etc., optionally pre-reacted with a compound such as diisopropenyl benzene (see, e.g., U.S. Pat. Nos. 5,153,159 and 5,567,815). Use of a N atom containing initiator such as, for example, lithiated HMI, can further enhance interactivity between the polymer chains and carbon black particles. See also, for example, U.S. Pat. Nos. 8,227,562, 8,871,871, 9,365,660, 10,277,425, 10,815,328, etc.

After introduction of the initiating compound, polymerization is allowed to proceed under anhydrous, anaerobic conditions for a period of time sufficient to result in the formation of the desired polymer, usually from ˜0.01 to ˜100 hours, more commonly from ˜0.08 to ˜48 hours, and typically from ˜0.15 to ˜2 hours.

After a desired degree of conversion has been reached, the heat source (if used) can be removed and, if the reaction vessel is to be reserved solely for polymerizations, the reaction mixture is removed to a post-polymerization vessel for further reaction.

Polymers made according to anionic techniques generally have a number average molecular weight (Mₙ) of up to ˜500,000 Daltons. In certain embodiments, the Mₙ can be as low as ˜2000 Daltons; in these and/or other embodiments, the Mₙ advantageously can be at least ˜10,000 Daltons or can range from ˜50,000 to ˜250,000 Daltons or from ˜75,000 to ˜150,000 Daltons. A preferred range is ˜75,000 to ˜225,000 Daltons, particularly from ˜100,000 to ˜200,000 Daltons. Often, the Mₙ is such that a quenched sample exhibits a gum Mooney viscosity (ML₄/100° C.) of from ˜2 to ˜150, more commonly from ˜2.5 to ˜125, even more commonly from ˜5 to ˜100, and most commonly from ˜10 to ˜75.

The functionalized EPDM and the carbanionic polymer can be reacted for 10 to 600 minutes a temperature of from ˜0° to ˜150° C., more commonly from about −10° to ˜100° C., and typically from ˜20° to ˜80° C. No catalysis is required, although maintenance of anaerobic and anhydrous conditions are preferred so as to maintain the activity of the carbanionic polymer chains.

As understood by ordinarily skilled artisans, the amounts of functionalized EPDM chains and the ratio of EPDM-to-carbanionic polymer can be used to control the amount of grafting. Additionally, although less preferably, an active H atom-containing compound can be introduced to the carbanionic polymer solution so as to reduce the number of living chains.

The resulting macromolecule, i.e., grafted EPDM, typically has a Mₙ of from ˜500 to ˜1250 kg/mol, often from ˜550 to ˜1100 kg/mol. Nevertheless, because so many grades of EPDM are available and because the molecular weight of anionically initiated polymers can be varied so readily, the foregoing ranges are merely exemplary and not to be considered limiting.

The macromolecule can be used as a component in vulcanizable compositions that include a wide variety of other polymers including without limitation natural or synthetic polyisoprene, with NR being preferred, and homo- and interpolymers of polyenes, particularly dienes and most particularly conjugated dienes. Exemplary conjugated dienes include 1,3-butadiene, 2-methyl-1,3-butadiene, 2,3-dimethyl-1,2-butadiene, 1,3-pentadiene, 1,3-hexadiene and the like, with 1,3-butadiene being particularly preferred. Those BRs having a 1,2-vinyl content of no more than 3% and a cis-1,4 content of at least 96 are preferred. A BR having up to ˜12%1,2-content also can be used with appropriate adjustments in the level of other components. (In this paragraph, all percentages are molar, such percentages being determined by various spectroscopic techniques.)

Interpolymers of conjugated diene monomers with at least one mono-olefin also can be included. Potentially useful mono-olefinic monomers include vinyl aromatic compounds (e.g., styrene, α-methyl styrene, vinyl naphthalene, vinyl pyridine, and the like) and a olefins (e.g., ethylene and propylene), as well as mixtures of the foregoing. Such interpolymers can contain up to 50%, preferably no more than ˜35% (both w/w), of mono-olefin mer. A preferred interpolymer of this type is SBR.

The rubber composition also can contain non-grafted EPDM. Any of a variety of grades, differing in terms of molecular weights, ethylene vs. propylene mer contents, particular type of diene monomer, etc., can be employed. Notwithstanding the ability of such other types of EPDM to be included, an advantage of the aforedescribed macromolecule is that it permits a lower amount of total EPDM to be included in a rubber composition yet still provide an acceptable level of resistance to cracking. Specifically, the total amount of EPDM included in such a composition is less than ˜25%, commonly less than 20%, typically less than 18%, preferably less than 15%, more preferably less than 13%, and most preferably less than 12% of the weight of all polymers used in the composition. In terms of ranges, the total amount of EPDM can be from 5 to 22%, commonly from 6 to 19%, typically from 7 to 17%, more typically from 8 to 16%, and most typically from 9 to 15%.

Any other polymer which does not interfere with the ability of the resulting rubber composition to provide a vulcanizate having desired physical properties can be employed in appropriate amounts. Non limiting examples include butyl rubber, neoprene, EPR, acrylonitrile/butadiene rubber, silicone rubber, fluoroelastomers, ethylene/acrylic rubber, EVA, epichlorohydrin rubbers, chlorinated polyethylene rubbers, chlorosulfonated polyethylene rubbers, hydrogenated nitrile rubber, tetrafluoroethylene/propylene rubber, and the like.

Polymers of the types described above can be compounded with, inter alia, reinforcing fillers. Elastomeric compounds typically are filled to a volume fraction, which is the total volume of filler(s) added divided by the total volume of the elastomeric stock, often ˜25%; typical (combined) amounts of reinforcing fillers range from ˜30 to ˜100 phr, with the upper end of the range being defined largely by how effectively processing equipment can handle the increased viscosities imparted when such fillers are employed.

Useful fillers include various forms of carbon black including, but not limited to, furnace black, channel blacks and lamp blacks. More specifically, examples of the carbon blacks include super abrasion furnace blacks, high abrasion furnace blacks, fast extrusion furnace blacks, fine furnace blacks, intermediate super abrasion furnace blacks, semi-reinforcing furnace blacks, medium processing channel blacks, hard processing channel blacks, conducting channel blacks, and acetylene blacks; mixtures of two or more of these can be used. Carbon blacks having a surface area (EMSA) of at least 20 m²/g, preferably at least about 35 m²/g, are preferred; see ASTM D-1765 for methods of determining surface areas of carbon blacks. The carbon blacks may be in pelletized form or an unpelletized flocculent mass, although unpelletized carbon black can be preferred for use in certain mixers.

The amount of carbon black can be up to ˜50 phr, with ˜5 to ˜40 phr being typical.

Amorphous silica (SiO₂) also can be utilized as a filler. Silicas are generally classified as wet-process, hydrated silicas because they are produced by a chemical reaction in water, from which they are precipitated as ultrafine, spherical particles. These primary particles strongly associate into aggregates, which in turn combine less strongly into agglomerates. “Highly dispersible silica” is any silica having a very substantial ability to de-agglomerate and to disperse in an elastomeric matrix, which can be observed by thin section microscopy.

Surface area gives a reliable measure of the reinforcing character of different silicas; the Brunauer, Emmet and Teller (“BET”) method (described in J. Am. Chem. Soc., vol. 60, p. 309 et seq.) is a recognized method for determining surface area. BET surface areas of silicas generally are less than 450 m²/g, commonly from ˜32 to ˜400 m²/g or from ˜100 to ˜250 m²/g or from ˜150 to ˜220 m²/g.

The pH of the silica filler (when used) is generally from ˜5 to ˜7 or slightly higher, preferably from ˜5.5 to ˜6.8.

When silica is employed, a coupling agent such as a silane often is added so as to ensure good mixing in, and interaction with, the elastomer(s). Generally, the amount of silane that is added ranges between about 4 and 20%, based on the weight of silica filler present in the elastomeric compound. Coupling agents can have a general formula of A-T-G, in which A represents a functional group capable of bonding physically and/or chemically with a group on the surface of the silica filler (e.g., surface silanol groups); T represents a hydrocarbon group linkage; and G represents a functional group capable of bonding with the elastomer (e.g., via a sulfur-containing linkage). Such coupling agents include organosilanes, in particular polysulfurized alkoxysilanes (see, e.g., U.S. Pat. Nos. 3,873,489, 3,978,103, 3,997,581, 4,002,594, 5,580,919, 5,583,245, 5,663,396, 5,684,171, 5,684,172, 5,696,197, etc.) or polyorganosiloxanes bearing the G and A functionalities mentioned above. Addition of a processing aid can be used to reduce the amount of silane employed; see, e.g., U.S. Pat. No. 6,525,118 for a description of fatty acid esters of sugars used as processing aids. Additional fillers useful as processing aids include, but are not limited to, mineral fillers, such as clay (hydrous aluminum silicate), talc (hydrous magnesium silicate), and mica as well as non-mineral fillers such as urea and sodium sulfate. Exemplary micas contain principally alumina, silica and potash, although other variants can be used. Additional fillers can be utilized in an amount of up to ˜40 phr, typically up to ˜20 phr.

Silica commonly is employed in amounts up to ˜ 100 phr, typically in an amount from ˜5 to ˜80 phr. When carbon black also is present, the amount of silica can be decreased to as low as ˜ 1 phr; as the amount of silica decreases, lesser amounts of the processing aids, plus silane if any, can be employed.

One or more non-conventional fillers having relatively high interfacial free energies, i.e., surface free energy in water values (ypl) can be used in conjunction with or in place of carbon black and/or silica. The term “relatively high” can be defined or characterized in a variety of ways such as, e.g., greater than that of the water air interface, preferably several multiples (e.g., at least 2×, at least 3× or even at least 4×) of this value; at least several multiples (e.g., at least 2×, at least 3×, at least 4×, at least 5×, at least 6×, at least 7×, at least 8×, at least 9× or even at least 10×) of the Yₚₗ value for amorphous silica; in absolute terms such as, e.g., at least ˜300, at least ˜400, at least ˜500, at least ˜600, at least ˜700, at least ˜750, at least ˜ 1000, at least ˜ 1500, and at least ˜2000 mJ/m². Non-limiting examples of naturally occurring materials with relatively high interfacial free energies include F-apatite, goethite, hematite, zincite, tenorite, gibbsite, quartz, kaolinite, all forms of pyrite, and the like. Certain synthetic complex oxides also can exhibit this type of high interfacial free energy.

The foregoing types of materials typically are more dense than either carbon black or amorphous silica; thus, replacing a particular mass of carbon black or silica with an equal mass of a non-conventional filler typically will result in a much smaller volume of overall filler being present in a given compound. Accordingly, replacement typically is made on an equal volume, as opposed to equal weight, basis.

Other conventional rubber additives also can be added. These include, for example, process oils, plasticizers, anti-degradants such as antioxidants and antiozonants, curing agents and the like. Advantageously, rubber compositions according to the present invention need not include as much antioxidant/antiozonant to provide vulcanizates with appropriate levels of ozone resistance.

All ingredients can be mixed with standard equipment such as, e.g., Banbury or Brabender mixers. Typically, mixing occurs in two or more stages. During the first stage (often referred to as the masterbatch stage), mixing typically is begun at temperatures of ˜120° to ˜130° C. and increases until a so-called drop temperature, typically ˜165° C., is reached.

Where a formulation includes fillers other than or in addition to carbon black, a separate re-mill stage often is employed for separate addition of the silane component(s). This stage often is performed at temperatures similar to, although often slightly lower than, those employed in the masterbatch stage, i.e., ramping from ˜90° C. to a drop temperature of ˜150° C.

Reinforced rubber compounds conventionally are cured with ˜0.2 to ˜5 phr of one or more known vulcanizing agents such as, for example, sulfur or peroxide-based curing systems. For a general disclosure of suitable vulcanizing agents, the interested reader is directed to an overview such as that provided in Kirk-Othmer, Encyclopedia of Chem. Tech., 3d ed., (Wiley Interscience, New York, 1982), vol. 20, pp. 365-468. Vulcanizing agents, accelerators, etc., are added at a final mixing stage. To reduce the chances of undesirable scorching and/or premature onset of vulcanization, this mixing step often is done at lower temperatures, e.g., starting at ˜60° to ˜65° C. and not going higher than ˜ 105° to ˜110° C.

Subsequently, the compounded mixture is processed (e.g., milled) into sheets prior to being formed into any of a variety of components and then vulcanized, which typically occurs at ˜5° to ˜15° C. higher than the highest temperatures employed during the mixing stages, most commonly about 170° C.

As is evident from the foregoing, general preferences regarding features, ranges, numerical limitations and embodiments are to the extent feasible, as long as not interfering or incompatible, envisioned as being capable of being combined with other such generally preferred features, ranges, and numerical limitations. The following enumerated embodiments are provided to assist in envisioning a few of such combinations.

### Process Embodiments

P1. A process for providing a macromolecule that comprises EPDM and a grafted chain which comprises polyene mer, said process comprising reacting a functionalized EPDM with a carbanionic polymer comprising polyene mer, wherein the functional group of said functionalized EPDM is reactive toward carbanions.
P2. The process of P1 wherein said functional group is an epoxy group.
P3. The process of P2 wherein said functionalized EPDM is the reaction product of an EPDM and m-chloroperoxybenzoic acid.
P4. The process of any of P1 to P3 wherein said carbanionic polymer consists of polyene mer.
P5. The process of any of P1 to P4 wherein said polyene is a conjugated diene.
P6. The process of any of P1 to P5 wherein said carbanionic polymer has a Mₙ of from 50 to 250 kg/mol.
P7. The process of P5 wherein said carbanionic polymer has a Mₙ of from 100 to 200 kg/mol.

### Macromolecule Embodiments

M1. A macromolecule comprising EPDM and a grafted chain that comprises polyene mer.
M2. The macromolecule of M1 wherein said grafted chain consists of polyene mer.
M3. The macromolecule of M1 or M2 wherein said polyene is a conjugated diene.
M4. The macromolecule of any of M1 to M3 wherein said grafted chain has a Mₙ of from 50 to 250 kg/mol.
M5. The macromolecule of M4 wherein said grafted chain has a Mₙ of from 100 to 200 kg/mol.
M6. The macromolecule of any of M1 to M5 having a Mₙ of from 400 to 1500 kg/mol.
M7. The macromolecule of M6 having a Mₙ of from 500 to 1250 kg/mol.

### Rubber Compound Embodiments

R1. A rubber composition comprising a macromolecule which comprises EPDM and a grafted chain that comprises polyene mer.
R2. The rubber composition of R1 wherein said composition is free of other polymers that comprise polyene mer.
R3. The rubber composition of R1 or R2 wherein the total amount of EPDM in said composition is no more than 15 phr.
R4. The rubber composition of R3 wherein the total amount of EPDM in said composition is no more than 10 phr.
R5. The rubber composition of any of R1 to R4 wherein said macromolecule has a Mₙ of from 400 to 1500 kg/mol.

Also contemplated are vulcanizates provided from any of R1 to R5.

The following non limiting, illustrative examples provide detailed conditions and materials that can be useful in the practice of the present invention. These examples employ 1,3-butadiene as an exemplary polyene due to a variety of factors including cost, availability, ability to handle and, most importantly, ability to make internal comparisons as well as comparisons against previously reported polymers. The ordinarily skilled artisan can extend these examples to polymers prepared from a variety of other polyenes.

### EXAMPLES

In the following examples, the n-butyllithium (n-BuLi) solution was 1.6 M and the 2,2-bis(2′-tetrahydrofuryl)propane (BTHFP) solution is 1.6 M, both in hexane.

Molecular weight values (all in kg/mol) of the polymer samples were determined by GPC, with THE as a solvent and calibrated with a series of polystyrene standards. The styrene and 1,2-linkage (vinyl) contents of the polymer samples were determined by NMR spectroscopy, while glass transition temperature (T_{g}) values were determined by DSC.

### Examples 1-2: BR

To a ˜7.5 L (2 gallon) N₂-purged reactor equipped with a stirrer was added 1.16 kg hexane and 3.27 kg 1,3-butadiene solution (20.8% (w/w) in hexane) followed by, sequentially, 0.14 mL BTHFP solution and 3.62 mL n-BuLi solution. The reactor jacket was heated to 65° C.

The batch temperature peaked at 99.8° C.

After an additional ˜60 minutes, the requisite amounts of polymer cement were charged into the bottles employed for Examples 4-7 below, with the remainder being dropped into ˜4 L of a mixture of 0.002 g 2,6-di-tert-butyl-4-methylphenyl (BHT) per mL of isopropanol.

The foregoing was repeated, with the only difference being that the batch temperature peaked at 98.3° C. This material is designated as Example 2 below.

### Example 3: Epoxidized EPDM

A glass bottle with 20 g EPDM was purged with N₂ for 30 minutes before 400 mL THF was added thereto.

After sitting overnight, the bottle was agitated for ˜6 hours at 65° C. before 1.86 g meta-chloroperoxybenzoic acid was added. Using a magnetic stirrer, the bottle contents were agitated at room temperature for ˜210 minutes.

The polymer cement was coagulated in isopropanol solution before being washed twice with isopropanol and then dried in a vacuum oven at 45° to 50° C. for ˜14 hours (85.9% yield).

For use in the grafting examples below, a solution of epoxidized EPDM (6.8% (w/w) in cyclohexane) was prepared by adding 15 g of the recovered EPDM polymer to a N₂-purged glass bottle followed by 300 mL cyclohexane and, after dissolution of the polymer, 20 g silica gel orange. The contents were magnetically stirred at room temperature until most bubbles had disappeared before the contents were transferred to a new N₂-purged bottle for purposes of removing the silica gel.

### Examples 4-11: Grafting

Four bottles containing 19 ml of the purified epoxidized EPDM solution from Example 2 were purged for ˜30 minutes with N₂. To each was added 31 mL of the polymer cement product of Example 1.

The bottle designated as Example 4 received no additional n-BuLi solution. The other three bottles received the following amounts of additional n′ BuLi solution:
Ex. 5-0.04 mL
Ex. 6-0.10 mL
Ex. 7-0.20 mL

Each bottle was well shaken (by hand) before being allowed to sit overnight.

The next day, 0.5 mL isopropanol was added to each bottle before the polymer cement was coagulated in isopropanol solution and washed twice with isopropanol.

Each polymer cement was dried in a vacuum oven at 45° to 50° C. for 6 hours.

GPC data for the polymers from Examples 1 and 3-7 are tabulated below, with all molecular weights being presented in terms of kg/mol. EPDM (Ex. 3) does not have a first peak but, after being grafted with a BR, the resulting grated polymer product does exhibit one. The ratio of first-to-second peak then can be used to estimate the amount of grafted polymer product.

TABLE 1
GPC data

| | 1 | 3 | 4 | 5 | 6 | 7 |
|---|---|---|---|---|---|---|
| 1st peak | | | | | | |
| Mₙ | 407 | | 514 | 633 | 623 | 578 |
| MWD | 1.02 | | 1.32 | 1.42 | 1.84 | 1.30 |
| Mₚ | 378 | | 395 | 398 | 401 | 404 |
| 2nd peak | | | | | | |
| Mₙ | 181 | 105 | 165 | 171 | 170 | 167 |
| MWD | 1.05 | 3.35 | 1.17 | 1.14 | 1.15 | 1.17 |
| Mₚ | 188 | 183 | 198 | 199 | 197 | 198 |
| Peak ratio | | | 0.157 | 0.240 | 0.224 | 0.197 |

The polymers from Examples 5-7 have a higher first-to-second peak ratio, suggesting that the addition of at least some additional initiator at the time of grafting might improve grafting efficiency. (This might be attributable merely to the additional initiator removing residual moisture and active H-containing materials such as isopropanol.)

In addition to the foregoing, the solution from Example 3 and the cement from Example 2 were used for further reactions, information about which are tabulated below. Each bottle was hand shaken for several minutes before being allowed to stand for 2 days, followed by quenching (0.5 mL isopropanol), coagulation in isopropanol solution, washing with isopropanol (twice), and drying in a vacuum oven (45°-50° C. for 6 hours).

TABLE 2
Grafting reaction details

Ex. 3

| | Ex. 2 | % solution | Amount |
|---|---|---|---|
| | (mL) | (w/w) | (mL) |
| 8 | 205 | 7.2 | 89 |
| 9 | 205 | 6.7 | 96 |
| 10 | 246 | 7.2 | 49 |
| 11 | 246 | 6.7 | 53 |

GPC data for the polymers from Examples 2 and 8.11 are tabulated below. (Example 3 data can be found in Table 1 above.) All molecular weights are presented in terms of kg/mol. With respect to the percentages, “BR %” represents the weight percentage of total polymers attributable to 1,3-butadiene mer, while the three percentages below that represent the weight percentages of polymers that did not graft (each of BR and EPDM) and those that did. (The last three numbers sum to 100, subject to rounding.)

TABLE 3
GPC data

| | 2 | 8 | 9 | 10 | 11 |
|---|---|---|---|---|---|
| 1st peak | | | | | |
| Mₙ | | 930 | 1000 | 966 | 963 |
| MWD | | 1.25 | 1.23 | 1.27 | 1.29 |
| Mₚ | | 517 | 562 | 719 | 725 |
| 2nd peak | | | | | |
| Mₙ | | 407 | 420 | 402 | 400 |
| MWD | | 1.02 | 1.03 | 1.02 | 1.02 |
| Mₚ | | 416 | 407 | 419 | 432 |
| 3nd peak | | | | | |
| Mₙ | 178 | 162 | 167 | 179 | 166 |
| MWD | 1.04 | 1.17 | 1.13 | 1.06 | 1.14 |
| Mₚ | 185 | 191 | 191 | 189 | 192 |
| BR % | 100 | 79 | 76 | 88 | 87 |
| Non-grafted BR % | — | 63 | 59 | 71 | 68 |
| Non-grafted EPDM % | — | 17 | 21 | 9 | 9 |
| EPDM-g-BR % | — | 20 | 20 | 20 | 22 |

### Examples 12-19: Rubber Compositions and Vulcanizates

Various polymers were combined during a masterbatch stage, while the same types and amounts of additives and curatives were during a final stage. The mill temperature for both stages was 65° C. (The EPDM is a commercially available material.)

Green rubber was cured at 171° C. to provide vulcanizates for physical testing.

Ozone resistance data was collected using equipment provided by Corporate Consulting Service & Instruments, Inc. (Akron, Ohio). Each specimen (75 mm×12 mm×2 mm) was set at 20% strain and 40° C. for 140 hours, with ozone concentration being held at 0.5 ppm during measurement. Each sample was given a grade based on the following scale:
A=no cracks
B=crack(s)
C=broken near the clip
D=broken

TABLE 4
Polymers included in compositions and vulcanizate testing

| | 12 | 13 | 14 | 15 | 16 | 17 | 18 | 19 |
|---|---|---|---|---|---|---|---|---|
| EPDM | 10.00 | 15.00 | 20.00 | 25.00 | | | | |
| Example 2 | 90.00 | 85.00 | 80.00 | 75.00 | 56.04 | 34.06 | 20.23 | — |
| Example 3 | | | | | | | | 2.90 |
| Example 8 | | | | | 21.98 | 32.97 | | |
| Example 9 | | | | | 21.98 | 32.97 | | |
| Example 10 | | | | | | | 39.98 | 48.55 |
| Example 11 | | | | | | | 39.98 | 48.55 |
| EPDM (%) | 10 | 15 | 20 | 25 | 10 | 15 | 10 | 15 |
| static ozone | D | C | B | A | A | A | A | A |
| grade | | | | | | | | |

The comparative vulcanizates (Examples 12-15) required 25% (w/w) EPDM before no cracking was observed. Conversely, each of vulcanizates containing a BR-grafted EPDM (Examples 16-19) received that grade, even though they contained significantly less EPDM than the Example 15 comparative.

Without wishing to be bound by theory, vulcanizes made from compositions containing BR-grafted EPDM (Examples 16-19) were seen to have much smaller EPDM domains (i.e., better dispersion) than the comparative Example 13 vulcanizate when subjected to transmission electron microscopy.

1. A macromolecule comprising EPDM and a grafted chain that comprises polyene mer wherein said grafted chain has an Mₙ of from 50 to 250 kg/mol.

2. The macromolecule of claim 1 wherein said grafted chain consists of polyene mer.

3. The macromolecule of claim 1 wherein said polyene is a conjugated diene.

4. The macromolecule of claim 1 wherein said grafted chain has a Mₙ of from 50 to 250-200 kg/mol.

5. The macromolecule of claim 4 wherein said grafted chain has a Mₙ of from 100 to 200 kg/mol.

6. The macromolecule of claim 1 having a Mₙ of from 400 to 1500 kg/mol.

7. The macromolecule of claim 6 having a Mₙ of from 500 to 1250 kg/mol.

8. A method for providing a macromolecule that comprises EPDM and a grafted chain which comprises polyene mer, said method comprising reacting a functionalized EPDM with a carbanionic polymer comprising polyene mer, wherein a functional group of said functionalized EPDM is reactive toward carbanions.

9. The method of claim 8 wherein said functional group is an epoxy group, said epoxy group optionally being provided by reaction of an EPDM and m-chloroperoxybenzoic acid.

10. The method of claim 8 wherein said carbanionic polymer consists of polyene mer.

11. The method of claim 8 wherein said polyene is a conjugated diene.

12. The method of claim 11 wherein said carbanionic polymer has a Mₙ of from 50 to 250 kg/mol.

13. The method of claim 12 wherein said carbanionic polymer has a Mₙ of from 100 to 200 kg/mol.

14. A tire sidewall comprising a rubber composition comprising a reinforcing filler, and a macromolecule which comprises EPDM and a grafted chain that comprises polyene mer, said composition optionally being free of other polymers that comprise polyene mer.

15. The tire sidewall of claim 14 wherein said macromolecule has a Mₙ of from 400 to 1500 kg/mol.

16. The tire sidewall of claim 14 wherein a total amount of EPDM in said composition is no more than 15 phr.

17. The tire sidewall of claim 16 wherein the total amount of EPDM in said composition is no more than 10 phr.

18. The tire sidewall of claim 14 wherein the grafted chain has an Mₙ of 50 to 250 kg/mol.

19. The macromolecule of claim 1, wherein the grafted chain is coupled to the EPDM via an epoxy group.

20. The macromolecule of claim 1, wherein the EPDM is a functionalized EPDM.
